(19) United States
(12) Patent Application Publication
(10) Pub. No.: US 2026/0162150 A1
(43) Pub. Date: Jun. 11, 2026

(54) REAL-TIME LIVE STREAMING CONTENT MONITORING AND AUTOMATED RESPONSE CONTROL SYSTEM FOR PROCESSING CONTINUOUS AUDIO DATA STREAMS

(71) Applicants: Alexander Guerrero, Weehawken, NJ (US); Matthew Goodman, Mill Valley, CA (US); Kyle Freedman, los angeles, CA (US); Jerome Aceti, nashville, TN (US); Deirdre Hynes, new providence, NJ (US); Jonathan Liebig, lieberg (DE)

(72) Inventors: Alexander Guerrero, Weehawken, NJ (US); Matthew Goodman, Mill Valley, CA (US); Kyle Freedman, los angeles, CA (US); Jerome Aceti, nashville, TN (US); Deirdre Hynes, new providence, NJ (US); Jonathan Liebig, lieberg (DE)

(21) Appl. No.: 19/264,561

(22) Filed: Jul. 9, 2025

Related U.S. Application Data
(60) Provisional application No. 63/729,971, filed on Dec. 10, 2024.

(51) Int. Cl. G06Q 30/0241; G10L 15/04; G10L 15/16; G10L 15/18; G10L 15/183; G10L 15/30; G10L 25/63; H04L 51/046

(52) U.S. Cl. CPC G06Q 30/0277; G10L 15/04; G10L 15/16; G10L 15/1807; G10L 15/183; G10L 15/30; G10L 25/63; H04L 51/046

(57) ABSTRACT

A real-time live streaming content monitoring and automated response control system processes continuous audio data streams through specialized hardware modules. The system includes a stream capture module with hardware circuitry that captures live audio streams and extracts data packets in real-time. An audio preprocessing module uses digital signal processing logic to receive encoded audio data, convert formats through codec transformation, and segment streams into predetermined audio chunks. A content analysis module transmits audio chunks to transcription services via secure API protocols and receives text transcriptions through encrypted channels. A contextual analysis module employs machine learning processing units to perform computational content evaluation when violations are detected. A decision engine module uses state machine hardware to evaluate content moderation scores against client-configured thresholds through automated comparison circuitry and manages operational state transitions. Finally, a logo control module interfaces with streaming platform servers through network protocols to execute real-time visibility commands by modifying browser source data streams or directing content production software to adjust visibility of certain content, enabling automated response control based on continuous monitoring analysis.

### CLAIM OF PRIORITY

This application claims priority to U.S. Provisional Patent Application No. 63/729,971, filed on Dec. 10, 2024. This provisional patent application is incorporated by reference in its entirety.

### BACKGROUND

### Technical Field

The present invention relates to real-time content monitoring systems for live streaming platforms, and more particularly to automated response control systems that process continuous audio data streams to enable dynamic content management and overlay visibility control in live broadcasting environments.

### Background of the Invention

Live streaming platforms have experienced unprecedented growth, with millions of content creators broadcasting real-time audio and video content to global audiences. These platforms, including Twitch, YouTube Live, TikTok Live, and similar services, generate continuous streams of audio data that require real-time monitoring and analysis for various content management purposes. The dynamic and unpredictable nature of live streaming content presents unique technical challenges for automated content monitoring systems.

Traditional content monitoring approaches are inadequate for live streaming environments due to several technical limitations. Pre-recorded content can be analyzed in its entirety before publication, but live streaming content must be processed in real-time as it is being broadcast. This creates significant latency constraints where content analysis, decision-making, and response actions must occur within milliseconds to be effective. Furthermore, live streaming content is inherently unpredictable, with content creators potentially changing topics, emotional tone, or language usage without warning, requiring continuous monitoring rather than periodic sampling.

Existing automated speech recognition (ASR) systems can convert speech to text but typically operate with significant processing delays that make them unsuitable for real-time response applications. Many ASR systems process audio in large batches, introducing latencies of several seconds or more before transcription results become available. Additionally, these systems often lack the contextual analysis capabilities needed to distinguish between benign and problematic uses of potentially sensitive language, leading to high rates of false positive detections.

Current content monitoring solutions also suffer from limited integration capabilities with live streaming infrastructure. Most systems operate as standalone analysis tools that cannot directly interface with streaming platforms to implement automated responses. This disconnection between content analysis and response mechanisms prevents real-time content management actions, such as dynamically controlling the visibility of digital overlays or advertisements embedded within live streams.

The technical challenges are further compounded by the need to process multiple data streams simultaneously. Live streaming environments generate not only continuous audio content from creators but also real-time text chat interactions from viewers. Comprehensive content monitoring requires analyzing both audio transcriptions and chat communications concurrently, correlating findings across these different data types, and making unified decisions based on the combined analysis results.

Scalability presents another significant technical hurdle. Live streaming platforms may host thousands of concurrent streams, each requiring individual monitoring and analysis. Traditional content monitoring approaches that rely on human reviewers or batch processing systems cannot scale to handle this volume of real-time content analysis while maintaining the low latency requirements necessary for effective automated responses.

Audio processing complexity adds additional technical challenges. Live streaming audio often contains background music, sound effects, multiple speakers, varying audio quality, and ambient noise that can interfere with accurate speech recognition and content analysis. Processing systems must be robust enough to extract meaningful content analysis from these challenging audio conditions while maintaining real-time performance requirements.

State management becomes critical in live streaming content monitoring systems due to the continuous nature of the content. Unlike discrete content items that can be evaluated independently, live streams require maintaining context across time, tracking content patterns, and managing system states that evolve as stream content changes. This necessitates sophisticated state machine architectures that can handle multiple operational modes and state transitions based on dynamic content analysis results.

Integration with external artificial intelligence services presents both opportunities and challenges. While leveraging cloud-based AI services can provide access to advanced natural language processing and machine learning capabilities without requiring substantial local infrastructure investment, it introduces network latency, service dependency, and data security considerations that must be carefully managed in real-time applications.

What is needed is a comprehensive real-time live streaming content monitoring and automated response control system that can process continuous audio data streams with minimal latency, perform sophisticated contextual content analysis, maintain complex operational states, and execute immediate automated responses through direct integration with streaming platform infrastructure. Such a system should be capable of handling multiple concurrent streams, processing both audio and text chat data, and providing configurable response thresholds while maintaining the scalability and reliability required for large-scale live streaming platform deployment.

### BRIEF SUMMARY OF THE INVENTION

In one aspect, a real-time live streaming content monitoring and automated response control system processes continuous audio data streams through an integrated architecture of specialized hardware modules. The system includes a stream capture module that comprises specialized hardware circuitry configured to capture live audio streams from streaming services and extract audio data packets in real-time. An audio preprocessing module comprises digital signal processing hardware that receives encoded audio data from the stream capture module, converts audio formats through hardware-based codec transformation, and segments the continuous audio stream into audio chunks of predetermined duration. A content analysis module comprises network interface hardware that transmits the audio chunks to external transcription services via secure API protocols and receives text-based transcriptions through encrypted data transmission channels. The system further incorporates a contextual analysis module comprising machine learning and/or AI processing units that perform computational content evaluation operations when potential content violations are detected by the content analysis module. A decision engine module comprises state machine hardware that evaluates content moderation scores against client-configured safety thresholds through automated threshold comparison circuitry and manages operational state transitions based on the evaluation results. Finally, a logo control module comprises digital overlay control hardware that interfaces with streaming platform servers through network protocols to execute real-time visibility commands from the decision engine module by modifying browser source data streams, thereby enabling automated response control based on the continuous content monitoring analysis.

In another aspect, a real-time live streaming content monitoring and automated response control method processes continuous audio data streams through systematic steps. The method begins by capturing a live audio stream from a streaming platform and processing the live audio stream through an audio preprocessing module to segment the live audio stream into audio chunks. The method transmits the audio chunks to a transcription service to generate a text transcription of spoken content, then analyzes the text transcription using a large language model service to generate a content moderation score. The method evaluates the content moderation score against predefined safety thresholds using a decision engine module and controls visibility of digital overlays in the live streaming environment based on the evaluation. The digital overlays are hidden when the content moderation score exceeds the predefined and configurable safety thresholds, enabling automated response control that maintains appropriate content standards while preserving streaming continuity through real-time monitoring and dynamic overlay management.

### BRIEF DESCRIPTION OF THE DRAWINGS

FIG. 1 is an illustration of a computerized process for monitoring of brand safety, according to an exemplary embodiment.

FIG. 2 illustrates an example brand-safety monitoring system, according to some embodiments.

FIG. 3 illustrates an example brand-safety monitoring system architecture, according to some embodiments.

FIG. 4 illustrates a logical view of brand-safety monitoring system architecture, according to some embodiments.

FIG. 5 illustrates an example process for Real-Time Brand Safety Monitoring, according to some embodiments.

FIG. 6 illustrates an example brand safety protection system, according to some embodiments.

FIG. 7 depicts an exemplary computing system that can be configured to perform any one of the processes provided herein.

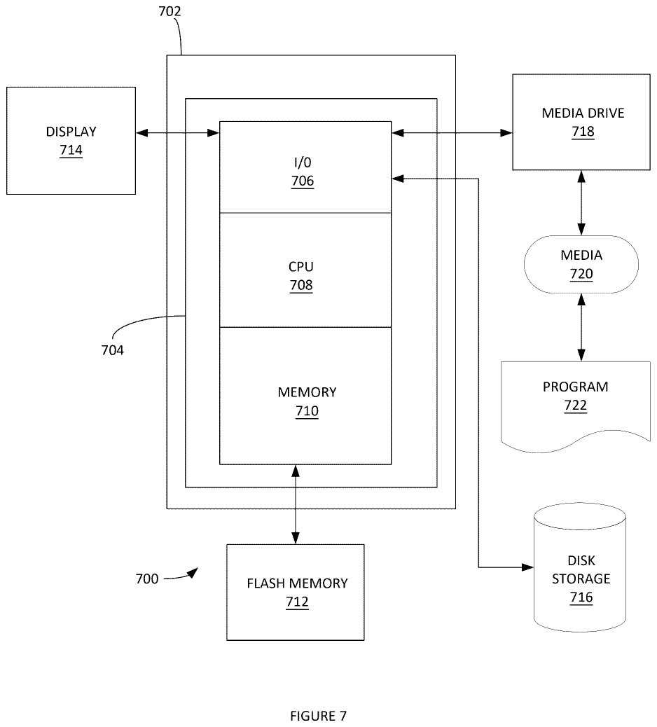

The Figures described above are a representative set and are not exhaustive with respect to embodying the invention.

### DESCRIPTION

Disclosed are a system, method, and article of manufacture of real-time live streaming content monitoring and automated response control system for processing continuous audio data streams. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided. These definitions can be used to

Application programming interface (API) is a way for two or more computer programs to communicate with each other. An API can be a type of software interface, offering a service to other pieces of software. A document or standard that describes how to build or use such a connection or interface is called an API specification. A computer system that meets this standard is said to implement or expose an API. In some examples, the term API may refer either to the specification or to the implementation.

BERT (Bidirectional Encoder Representations from Transformers) is a natural language processing model.

Deep learning can be a machine learning method(s) based on artificial neural networks with representation learning. Deep learning can use multiple layers in the network. Methods used can be either supervised, semi-supervised or unsupervised. Deep-learning architectures such as deep neural networks, deep belief networks, deep reinforcement learning, recurrent neural networks, convolutional neural networks and transformers.

A live streaming environment can be a digital ecosystem that enables real-time video/audio broadcasting over the internet. Livestreaming can be the streaming of video or audio in real time or near real time. This can include an ecosystem that allows content creators to broadcast live content while viewers can watch and interact in real-time. Livestreaming services can include social media, video games, professional sports, and lifecasting.

Large Language Model (LLM) is an artificial intelligence system based on deep learning architectures, typically utilizing transformer neural networks, that has been trained on vast amounts of text data to understand, generate, and manipulate human language. LLMs can perform various natural language processing tasks including text classification, sentiment analysis, content moderation, contextual understanding, and text generation. These models typically contain billions or trillions of parameters and are trained using unsupervised or semi-supervised learning methods on diverse text corpora from the internet, books, and other written sources. LLM Service in the context of the brand safety monitoring system refers to a cloud-based artificial intelligence service that provides advanced natural language processing capabilities for contextual content analysis and moderation. The LLM Service receives transcribed text from the transcription service and performs sophisticated content evaluation to determine whether potentially problematic language is being used in harmful or benign contexts. The LLM Service analyzes larger text context windows to generate comprehensive content moderation scores with enhanced contextual understanding, supporting the system's ability to make nuanced determinations about content appropriateness. The LLM Service operates through API endpoints and can be provided by various external providers or implemented using models such as GPT, BERT, T5, BART, or other transformer-based architectures optimized for content classification and safety evaluation tasks.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning.

Natural Language Processing (NLP) is a field of artificial intelligence that focuses on the interaction between computers and human language. NLP aims to enable machines to understand, interpret, and generate human language in a valuable way. NLP systems and methods used herein combine computational linguistics, machine learning, and deep learning techniques to process and analyze large amounts of natural language data. NLP has a wide range of applications, including machine translation, sentiment analysis, speech recognition, and chatbots. NLP technologies can be used here with deep learning and CNN, transformer-and diffusion-models to manage and/or enhance one more language-based AI systems. Example NLP algorithms and techniques can include, inter alia: Tokenization Part-of-Speech (POS); Tagging Named Entity Recognition (NER); Sentiment Analysis Text Classification Word Embedding (e.g. Word2Vec, GloVe); Recurrent Neural Networks (RNNs); Long Short-Term Memory (LSTM) networks; Transformer models (e.g. BERT, GPT); Latent Dirichlet Allocation (LDA) for topic modeling; Conditional Random Fields (CRFs); Hidden Markov Models (HMMs); Naive Bayes Classifier Support Vector Machines (SVMs) for text classification; Seq2Seq models; for machine translation; Attention mechanisms; Dependency Parsing; Coreference Resolution Text Summarization algorithms; Stemming and Lemmatization techniques; etc. These algorithms and techniques can be combined or used as components of complex NLP systems (e.g. can be used by process 100, system 200, etc.). An NLP model is a computational system designed to understand, interpret, and generate human language. An NLP model processes and analyzes human language data and uses algorithms and statistical methods to recognize patterns in text or speech.

Prosodic features are the elements of speech that go beyond individual sounds (e.g. phonemes) and include, inter alia: pitch/intonation (e.g. the rise and fall of voice); changes in speaking melody; tonal patterns that can indicate questions, statements, or emotions; stress/emphasis (e.g. which syllables or words receive more force); how speakers highlight important information; patterns of strong and weak beats in speech; rhythm (e.g. timing patterns in speech); speed of delivery; pausing patterns; volume/loudness changes in speaking volume; dynamic range of speech; etc.

Transcription Service is an automated speech recognition (e. g either internal or external etc) (ASR) system that converts spoken audio content into written text in real-time or near real-time. A transcription service processes audio data streams and returns text-based transcriptions of the spoken content, often including additional metadata such as timestamps, speaker identification, confidence scores, and content moderation assessments. These services utilize advanced machine learning models, including deep neural networks and transformer-based architectures, to achieve high accuracy across different languages, accents, and audio quality conditions. Transcription services can operate through cloud-based APIs that accept audio input in various formats and return structured text output, enabling integration into larger systems for content analysis, searchability, and automated processing workflows. The transcription service can provide automatic speech recognition capabilities through a cloud-based API platform. Transcription services processes audio files and live audio streams to generate accurate transcriptions while offering additional features such as speaker diarization to identify different speakers, content moderation to flag potentially harmful or inappropriate content, topic detection to identify key themes within the audio, and sentiment analysis to assess emotional tone. Transcription Service supports multiple audio formats and languages, provides real-time streaming transcription capabilities for live audio processing, and returns structured JSON responses containing transcribed text along with confidence scores and optional content safety assessments. Transcription Service is designed for enterprise applications requiring scalable, accurate speech-to-text conversion with additional AI-powered content analysis capabilities.

### Example Embodiments

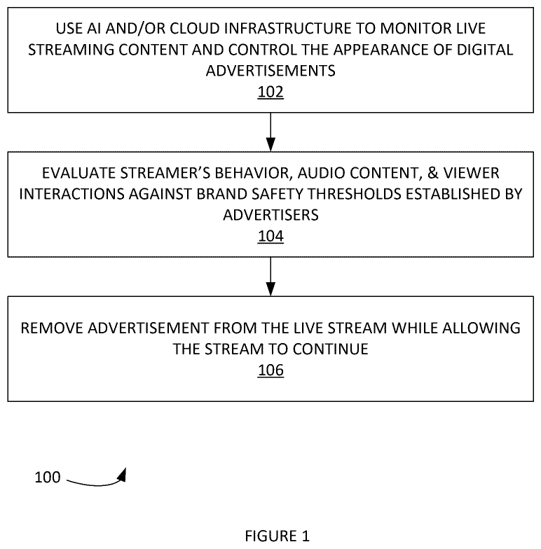

FIG. 1 is an illustration of a computerized process 100 for monitoring of brand safety, according to an exemplary embodiment. Process 100 is a brand safety monitoring system for digital advertisements within live streaming environments. In step 102, process 100 uses artificial intelligence (AI) and/or cloud infrastructure to monitor live streaming content and control the appearance of digital advertisements. Process 100 can evaluates a streamer's behavior, audio content, and viewer interactions against brand safety thresholds established by advertisers in step 104. If any of these thresholds are violated, process 100 removes the advertisement from the live stream while allowing the stream to continue in step 106.

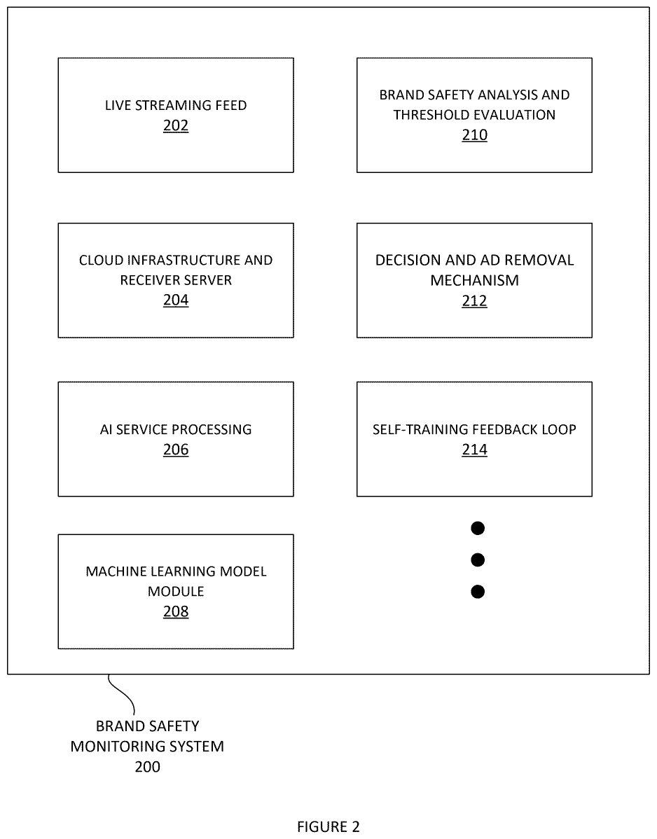

FIG. 2 illustrates an example brand-safety monitoring system 200, according to some embodiments. Brand-safety monitoring system 200 can use AI and/or cloud infrastructure to monitor live streaming content and control the appearance of digital advertisements. Brand-safety monitoring system 200 can evaluate a streamer's behavior, audio content, and viewer interactions against brand safety thresholds established by advertisers. Brand-safety monitoring system 200 can remove any advertisement from the live stream while allowing the stream to continue when violations are detected. Brand-safety monitoring system 200 can implement process 100. Brand-safety monitoring system 200 can thus enable advertisers to engage in live streaming platforms without compromising brand safety. Brand-safety monitoring system 200 can enable more nuanced control over where and when advertisements appear, and offering immediate corrective actions when content veers off-brand.

Live Streaming Feed 202 is now discussed. When a streamer goes live on a streaming platform (e.g., Twitch, YouTube Live, TikTok, Instagram Live, Kick), their content appears in a streaming window. A digital advertisement is embedded within the streaming window alongside the streamer's content, forming a Produced Feed. The Produced feed can also include a video/image of the Content Creator/Streamer. The Produced Feed is then transmitted to the streaming platform, making it accessible to the viewer. Alternatively, the digital advertisement can also be embedded to the produced feed by the streamer instead. This advertising content then is controlled by the streamer instead of the streaming platform.

Cloud Infrastructure and Receiver Server 204 is now discussed. The Produced Feed is also sent to the Cloud Infrastructure and Cloud Infrastructure Receiver Server 204 via a Streaming Platform. Cloud Infrastructure and Receiver Server 204 includes a Receiver Server. A Receiver Server watches and monitors the stream. Further, the Receiver Server captures the corresponding platform chat. The Receiver Server acts as an intermediary to capture and analyze the live stream in real time.

AI Service Processing 206 is now discussed. The Receiver Server forwards the stream to AI Service Processing 206 using secure tokens to ensure data integrity and security. AI Service Processing 206 processes the stream and returns four (by way of example) data points. A Transcript of Audio can be returned. A text-based transcription of the audio content from the stream. An Emotional Tone Assessment can be returned. This can be an analysis of the streamer's emotional tone, detecting whether the streamer is expressing emotions such as anger or frustration and any significant deviations from their typical tone. A Topic Summary (e.g. of Streamer Content) can be returned. This can be a summary of the main topics or themes being discussed by the streamer at a given point in time. A Topic Summary (e.g. a Chat Log) can be returned. A summary of the key topics emerging from viewer comments in the chat log. The algorithm constantly evaluates the last few seconds of audio and creates a live-classification for any given moment. This live classification is rolling and updated immediately based on the 50-400 ms audio window size used by the algorithm. No post-mortem content classification is required. In one example, AI Service Processing 206 can begin with a secure stream processing pipeline where the Receiver Server transmits the live stream data to an AI Service using (by way of example and not of limitation) JWT or OAuth2 tokens for authentication and encryption. This ensures end-to-end security and data integrity throughout the processing chain. For audio transcription, AI Service Processing 206 can employ a deep learning model (e.g. Whisper or DeepSpeech by way of example, and/or any other automatic speech recognition (ASR) system(s)) which processes the audio stream in real-time using a sliding window approach.

ASR systems can convert speech to text. ASR systems used herein can include multilingual support. ASR systems can implement multilingual data robust performance across different accents and background noise. In some examples, an open-source speech-to-text engines can be used that include end-to-end deep learning architecture. This can be built using TensorFlow Streaming transcription capabilities, built-in acoustic model training, language model support for improved accuracy and/or support for custom vocabulary and language models. ASR systems can be trained using deep neural networks and use a CNN, transformer or diffusion based architecture; recurrent neural networks (RNNs); etc.

The model converts the speech to text while handling multiple speakers, background noise, and various accents. The transcription can be continuously updated and segmented into meaningful units based on natural speech patterns and pauses. The emotional tone assessment can utilize a multi-modal analysis system combining both audio and text features or use only audio or only text. For audio, AI Service Processing 206 can extract prosodic features such as pitch variation, speech rate, and volume using an audio processing library(s) (e.g. librosa, etc.). These features can then be fed into a trained neural network that identifies emotional states. Simultaneously, the transcribed text can be analyzed using a BERT-based sentiment analysis model (and/or similar type of natural language processing model) that has been fine-tuned on streaming content.

AI Service Processing 206 can maintain a rolling baseline of the streamer's typical emotional patterns and flags significant deviations. For the streamer content summarization, AI Service Processing 206 implements an extractive-abstractive hybrid approach. The extractive component uses an algorithm used for automated text summarization and keyword extraction (e.g. TextRank or similar algorithms) to identify key sentences and topics from the transcribed content. The abstractive component (e.g. can be powered by a fine-tuned T5 or BART model) generates natural language summaries of the main discussion points. AI Service Processing 206 can update these summaries incrementally as new content arrives and thus, maintain context across the stream duration.

AI Service Processing 206 can provide a chat log. The chat log analysis employs a specialized NLP pipeline designed for processing informal, real-time conversation data. It first applies preprocessing to handle emotes, acronyms, and chat-specific language. Then, it uses a combination of topic modeling (like LDA) and clustering algorithms to identify emerging themes and patterns in viewer comments. A transformer-based summarization model generates concise summaries of the main discussion threads, while filtering out noise and irrelevant content. All four components operate concurrently and are orchestrated by a message queue system (e.g. Kafka or RabbitMQ) to handle the real-time nature of the data. AI Service Processing 206 can maintain state using a distributed cache (e.g. Redis) to track context and patterns across time. Results are continuously aggregated and updated, with the system providing both real-time insights and periodic summary updates at configurable intervals.

Brand Safety Analysis and Threshold Evaluation 210 is now discussed. The data returned from the AI Service 206 is sent to Cloud Infrastructure, where it is analyzed according to brand safety thresholds pre-set by the campaign manager. These thresholds and tolerance levels may vary between brands, allowing customization at both the campaign and brand level. For instance, some brands may have a higher tolerance for informal language, while others require stricter controls. If the analysis reveals that the content exceeds any threshold (e.g. contains inappropriate language, off-topic discussions, or shows a negative emotional tone), the system flags the content as non-compliant with brand safety standards.

Decision and Ad Removal Mechanism 212. Decision and Ad Removal Mechanism 212 can be instantiated in a Sponsor Control Server. System 200 then sends a decision to the Decision and Ad Removal Mechanism 212 in the Sponsor Control Server. If the content is deemed non-compliant based on the individual threshold set, the Sponsor Control Server removes the specific digital advertisement from the Produced Feed in real time. The removal process happens seamlessly, ensuring that the live stream continues uninterrupted but without the advertisement present.

Self-Training Feedback Loop 214 is now discussed. System 200 includes a training loop (e.g. Self-Training Feedback Loop 214) that adjusts its sensitivity and reduces false positives over time. By analyzing flagged content and advertiser feedback, the system learns to refine its decision-making criteria, improving its accuracy in identifying potentially brand-damaging content.

Machine-learning module 208 can use various databases to generate ML models used by AI Service Processing 206. Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning. Random forests (RF) (e.g. random decision forests) are an ensemble learning method for classification, regression and other tasks, which operate by constructing a multitude of decision trees at training time and outputting the class that is the mode of the classes (e.g. classification) or mean prediction (e.g. regression) of the individual trees. RFs can correct for decision trees'habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, which is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. This procedure is complicated in practice by the fact that the validation dataset's error may fluctuate during training, producing multiple local minima. This complication has led to the creation of many ad-hoc rules for deciding when overfitting has truly begun. Finally, the test dataset is a dataset used to provide an unbiased evaluation of a final model fit on the training dataset. If the data in the test dataset has never been used in training (for example in cross-validation), the test dataset is also called a holdout dataset.

The entire system 200 can be built to be scalable and fault-tolerant, using microservices architecture and containerization. Each component can be scaled independently based on load, and the system includes robust error handling and fallback mechanisms to maintain service continuity even if individual components experience issues.

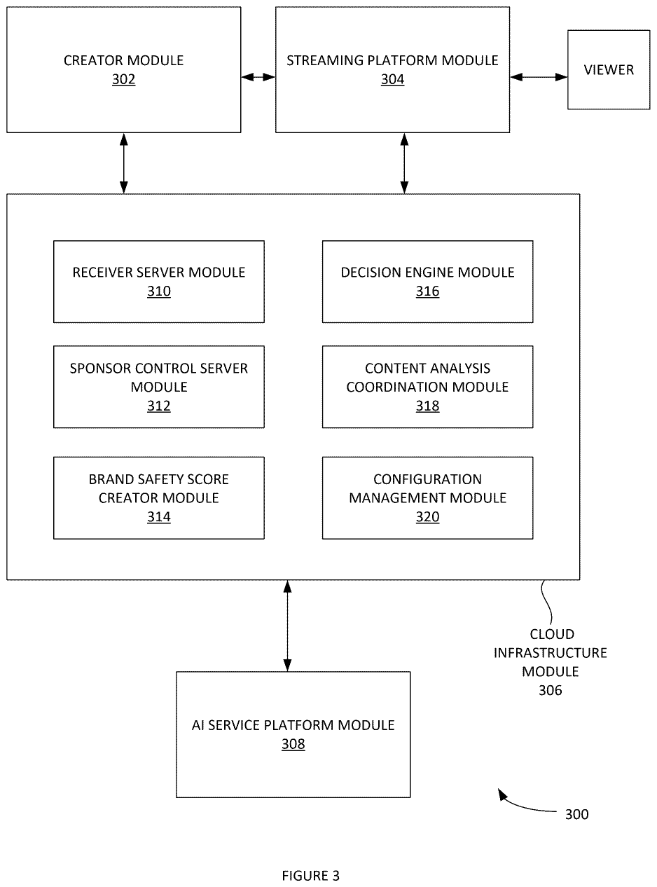

FIG. 3 illustrates example brand-safety monitoring system architecture 300, according to some embodiments. It is noted that brand-safety monitoring system architecture 300 can be integrated in whole or in part with brand-safety monitoring system 200. As shown, brand-safety monitoring system architecture 300 can be segmented into four entities/modules: Creator, Streaming Platform, Cloud Infrastructure, and an AI Service Platform. Within the Creator module, a streamer's chatting and/or commentating can be combined with background media (e.g. video games, videos, etc.). The creator module can produce a creator stream. The creator stream can then be transmitted to the Streaming Platform.

The Streaming Platform can function as an intermediary in brand-safety monitoring system architecture 300. The Streaming Platform can direct the stream to both viewers and to the Receiver Server.

The Receiver Server monitors the stream. The Receiver Service can then forward the audio feed to the AI Service Platform. Within the Cloud Infrastructure, a Sponsor Control Server (e.g. Tether) can be implemented to manage sponsor playout. The Sponsor Control Server can be connected to a Brand Safety Score Creator. The Brand Safety Score Creator can automatically evaluate content of each stream for banned words, actions, content and tone. The Brand Safety Score Creator can be a self-trained AI system. The AI Service Platform can manage the processing of the audio feed. The AI Service platform can perform transcription, topic-and content safety analysis and emotional tone analysis.

FIG. 3 illustrates an example brand-safety monitoring system architecture 300, according to some embodiments. It is noted that brand-safety monitoring system architecture 300 can be integrated in whole or in part with brand-safety monitoring system 200. As shown, brand-safety monitoring system architecture 300 can be segmented into four entities/modules: Creator Module 302, Streaming Platform Module 304, Cloud Infrastructure Module 306, and AI Service Platform Module 308.

Within Creator Module 302, a streamer's chatting and/or commentating can be combined with background media such as video games, videos, and other digital content. Creator Module 302 can produce a creator stream that includes both the content creator's audio commentary and any accompanying visual or audio elements from their broadcast environment. The creator stream can then be transmitted to Streaming Platform Module 304 for distribution and processing.

Streaming Platform Module 304 functions as an intermediary in brand-safety monitoring system architecture 300, serving multiple distribution pathways simultaneously. Streaming Platform Module 304 can direct the stream to both viewers for consumption and to the Receiver Server within Cloud Infrastructure Module 306 for monitoring purposes. This dual-path approach ensures that content reaches its intended audience while enabling real-time safety monitoring without interrupting the viewing experience. This process happens analog to watching a stream on a browser or device.

Cloud Infrastructure Module 306 houses the core monitoring and control infrastructure for the brand safety system. Within Cloud Infrastructure Module 306, a Receiver Server monitors the incoming stream data and captures corresponding platform chat interactions for comprehensive content analysis. The Receiver Service can then forward the audio feed to AI Service Platform Module 308 for processing and evaluation. Cloud Infrastructure Module 306 also implements a Sponsor Control Server (e.g., Tether) to manage sponsor playout and advertisement visibility decisions. The Sponsor Control Server can be connected to a Brand Safety Score Creator that automatically evaluates content of each stream for banned words, actions, content, and emotional tone using configurable thresholds established by advertisers. The Brand Safety Score Creator can be a self-trained AI system that incorporates feedback on flagged content to improve the system's understanding and decrease false positives over time.

Cloud Infrastructure Module 306 houses the core monitoring, analysis, and control systems for brand safety management and comprises several specialized sub-modules:

Receiver Server Module 310 monitors the incoming stream from Streaming Platform Module 304 and captures the live audio feed for processing. Receiver Server Module 310 “watches” the stream in real-time and forwards audio data to AI Service Platform Module 308 while also capturing corresponding platform chat interactions for comprehensive content analysis.

Sponsor Control Server Module 312 (e.g. Tether) manages sponsor playout control and advertisement visibility decisions. Sponsor Control Server Module 312 can dynamically shut off individual sponsors based on brand-safety score evaluations and sends control signals to Creator Module 302 to hide or show sponsor overlays in real-time without interrupting the underlying stream content.

Brand Safety Score Creator Module 314 automatically evaluates content of each stream for banned words, actions, content, and emotional tone using configurable thresholds established by advertisers. Brand Safety Score Creator Module 314 can be implemented as a self-trained AI system that incorporates feedback on flagged content to improve the system's understanding and decrease false positives over time.

Decision Engine Module 316 evaluates all content moderation scores against client-configured safety thresholds and manages the system's operational state through a comprehensive state machine architecture. Decision Engine Module 316 implements multiple operational states including CONTENT_OK, ANALYSIS_PARTIAL, ANALYSIS_FULL, and CONTENT_BAD, making binary content safety decisions of either SHOW_AD or HIDE_AD.

Content Analysis Coordination Module 318 manages communication between Cloud Infrastructure Module 306 and AI Service Platform Module 308, processing transcription results and moderation scores returned from external AI services. Content Analysis Coordination Module 318 determines when deeper contextual analysis is required and coordinates with Contextual Analysis Module 608 for comprehensive content evaluation.

Configuration Management Module 320 stores and manages client-specific brand safety parameters including per-topic threshold settings aligned with IAB taxonomy categories, safety mode toggles for conservative, balanced, or aggressive response profiles, and recovery timeout configurations that determine logo restoration timing after violations are resolved.

AI Service Platform Module 308 manages the processing of the audio feed received from Cloud Infrastructure Module 306, performing transcription and emotional tone analysis through integration with external artificial intelligence services. AI Service Platform Module 308 can employ transcription services such as AssemblyAI, Google Cloud, or AWS to convert spoken content to text for topic and sentiment analysis. The platform can utilize deep learning models including Whisper™ or DeepSpeech™ for automatic speech recognition, processing audio streams in real-time using sliding window approaches to handle multiple speakers, background noise, and various accents. AI Service Platform Module 308 can implement emotional tone assessment utilizing multi-modal analysis systems combining both audio and text features, extracting prosodic features such as pitch variation, speech rate, and volume using audio processing libraries. These features can be fed into trained neural networks that identify emotional states while simultaneously analyzing transcribed text using BERT-based sentiment analysis models fine-tuned on streaming content.

Brand-safety monitoring system architecture 300 can control sponsor playout dynamically based on content evaluation results. Individual sponsors can be shut off based on the brand safety scores generated through the integrated analysis pipeline. The interconnections between the brand-safety monitoring system architecture 300 entities/modules can be facilitated through various data streams and control signals. Brand-safety monitoring system architecture 300 manages control signals being passed between the Sponsor Control Server and the Creator's sponsor playout functionality, enabling real-time advertisement removal when content violations are detected. The system can maintain a rolling baseline of the streamer's typical emotional patterns and flags significant deviations, while implementing extractive-abstractive hybrid approaches for content summarization that update incrementally as new content arrives. In this way, brand-safety monitoring system architecture 300 can be structured to enable real-time monitoring and response to potential content concerns while allowing customization at both campaign and brand levels for different tolerance thresholds and safety requirements.

Brand-safety monitoring system architecture 300 can control sponsor playout. Additionally, individual sponsors can be shut off based on the brand safety scores. The interconnections between the brand-safety monitoring system architecture 300 entities/modules can be facilitated through various data streams. Brand-safety monitoring system architecture 300 manages control signals being passed between the Sponsor Control Server and the Creator's sponsor playout functionality. In this way, brand-safety monitoring system architecture 300 can be structured to enable real-time monitoring and response to potential content concerns.

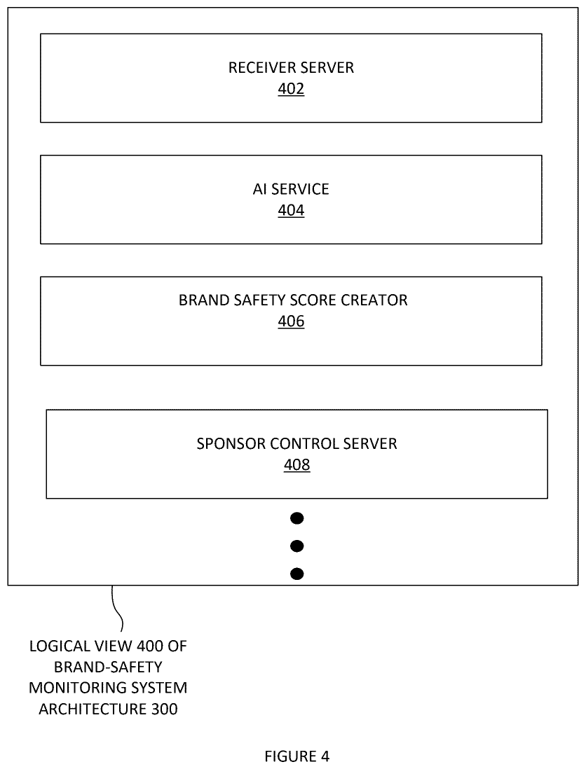

FIG. 4 illustrates a logical view 400 of brand-safety monitoring system architecture 300, according to some embodiments. Logical view 400 includes Receiver Server 402. Receiver Server 402 is configured to monitor the Produced Feed, captures the live stream (in some examples, those feeds can be the same), and sends it to the AI Service 404 for processing.

An AI Service 404 manages transcription and converts spoken content to text for topic and sentiment analysis. AI Service 404 can implement emotional tone detection. AI Service 404 evaluates the emotional tone of the streamer to detect any potential shifts that might suggest elevated risk. AI Service 404 performs topic summarization (e.g. streamer and chat). AI Service 404 summarizes main themes in both the streamer's dialogue and viewer chat to identify sensitive topics.

Brand Safety Score Creator 406 analyzes and creates brand safety thresholds set by campaign managers. Brand Safety Score Creator 406 can incorporate feedback on flagged content to improve the system's understanding and decrease false positives. Brand Safety Score Creator 406 can include training system to improve the accuracy and recoil of the Safety Score.

Sponsor Control Server 408 controls the appearance of advertisements within the Produced Feed. Sponsor Control Server 408 immediately (e.g. assuming processing and networking latencies, etc.) removes any advertisement if the relevant brand safety thresholds of that advertiser are violated.

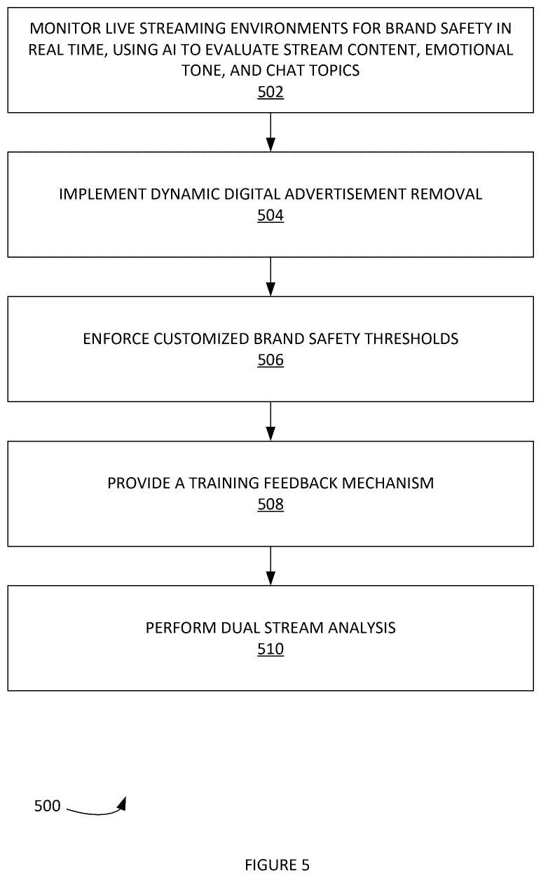

FIG. 5 illustrates an example process 500 for Real-Time Brand Safety Monitoring, according to some embodiments. In step 502, process 500 monitors live streaming environments for brand safety in real time, using AI to evaluate stream content, emotional tone, and chat topics. In step 504, process 500 implements dynamic digital advertisement removal. Here, process 500 dynamically removes digital advertisements from live streams based on brand safety evaluations, where advertisements are withdrawn from a produced feed if thresholds are violated and can further be withdrawn for embedded advertising next to the produced feed, including but not limited to L-frame, chat bot messages, etc. In step 506, process 500 enforces customized brand safety thresholds. Here, process 500 can leverage a configurable brand safety monitoring system that allows for setting specific tolerance levels for brand safety according to campaign or brand-specific requirements.

In step 508, process 500 can provide a training feedback mechanism. This can include an adaptive feedback loop within the system that refines its decision criteria based on historical data and other inputs, reducing false positives and improving accuracy.

In step 510, process 500 can perform dual stream analysis (e.g. for digital content and chat). Process 500 provides the ability to analyze both the streamer's content and the live chat discussion concurrently to assess brand safety risk comprehensively.

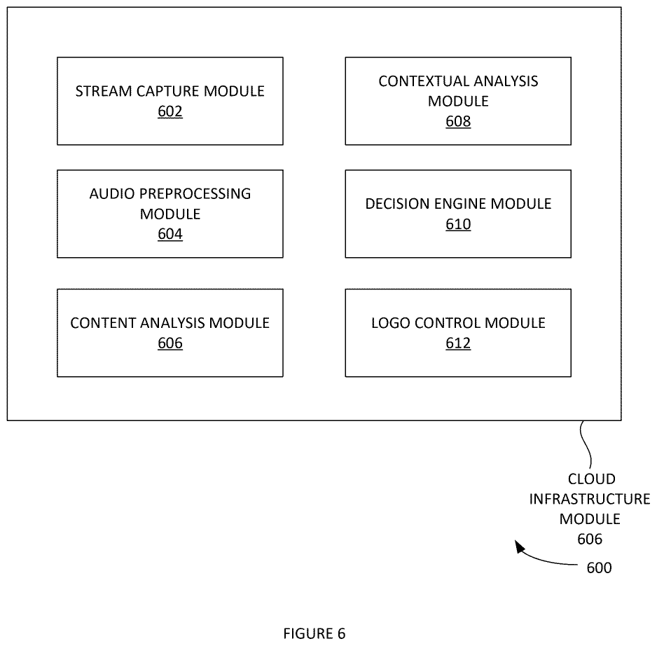

FIG. 6 illustrates an example brand safety protection system 600, according to some embodiments. Brand safety protection system 600 provides real-time content monitoring and automated logo visibility control for live streaming environments through a modular architecture of interconnected components.

The Stream Capture Module 602 serves as the entry point for the system, capturing live audio streams from various streaming services including Twitch, YouTube, and Kick through a service-independent architecture. Stream Capture Module 602 extracts audio data from multiple streaming platforms via established APIs and interfaces, ensuring compatibility across different broadcasting environments without platform-specific dependencies.

The Audio Preprocessing Module 604 receives encoded audio data from Stream Capture Module 602 and processes it for analysis. Audio Preprocessing Module 604 converts audio formats such as AAC-LC encoded via MPEG-TS into required formats like PCM16_LE for transcription services. Audio Preprocessing Module 604 segments the continuous audio stream into appropriate chunks of approximately 400 ms based on transcription service requirements, maintaining audio quality while enabling real-time processing. The segmented audio is then piped to the Content Analysis Module 606 for immediate evaluation.

The Content Analysis Module 606 manages communication with external transcription services and performs initial content evaluation. Content Analysis Module 606 sends processed audio chunks to live transcription services such as AssemblyAI™, Google Cloud™, or AWS™ transcription endpoints and receives text-based transcriptions in return. When transcription services include built-in content moderation capabilities, Content Analysis Module 606 extracts moderation scores directly and forwards them to the Decision Engine Module 610. For transcription services that provide only text output, Content Analysis Module 606 sends the extracted text to LLM-based classification services or checks transcriptions against predefined blacklists to detect potentially harmful content. Upon detecting suspicious content, Content Analysis Module 606 determines whether deeper contextual analysis is required and may instruct the Logo Control Module 612 to temporarily hide the brand logo during extended analysis periods.

The Contextual Analysis Module 608 provides comprehensive content evaluation when potential brand safety violations are detected by Content Analysis Module 606. Contextual Analysis Module 608 operates in two distinct modes to ensure accurate content assessment. In text mode, Contextual Analysis Module 608 analyzes larger text context windows using AI-powered classification services via LLM endpoints to generate comprehensive content moderation scores with enhanced contextual understanding. In audio mode, Contextual Analysis Module 608 captures extended audio context spanning approximately 15 seconds of historical content and submits this larger audio segment to specialized transcription services for deeper analysis, potentially utilizing different services than those used for live transcription to leverage specialized analytical capabilities. Contextual Analysis Module 608 forwards detailed content safety scores with confidence ratings to Decision Engine Module 610 for final evaluation.

The Decision Engine Module 610 evaluates all content moderation scores against client-configured safety thresholds and manages Brand safety protection system 600′s operational state through a comprehensive state machine architecture. Decision Engine Module 610 implements multiple operational states including CONTENT_OK as the default safe state, ANALYSIS_PARTIAL during initial content evaluation, ANALYSIS_FULL during comprehensive contextual analysis, and CONTENT_BAD when brand safety violations are confirmed. Decision Engine Module 610 makes binary content safety decisions of either SHOW_AD to maintain logo visibility or HIDE_AD to remove brand elements from the stream. Decision Engine Module 610 incorporates client-specific configuration parameters including per-topic threshold settings aligned with IAB taxonomy categories, safety mode toggles for conservative, balanced, or aggressive response profiles, and recovery timeout configurations that determine logo restoration timing after violations are resolved.

The Logo Control Module 612 interfaces directly with the NexTide Ad-Platform to execute visibility commands from Decision Engine Module 610. Upon receiving a HIDE_AD command, Logo Control Module 612 sends requests to remove the client's logo from the browser source embedded in the streamer's broadcasting software such as OBS or StreamElements. When receiving a SHOW_LOGO command, Logo Control Module 612 sends requests to restore normal logo visibility by re-enabling ad serving to the browser source endpoint. Logo Control Module 612 provides acknowledgment responses confirming successful execution of visibility changes and maintains communication with the ad serving infrastructure to ensure seamless logo management without interrupting the underlying live stream content.

Brand safety protection system 600 utilizes a browser source integration approach where streamers embed a single source into their streaming platforms such as OBS or StreamElements. This browser source continuously reaches out to the NexTide platform to retrieve advertisement content, and when content violations are detected, the ad server simply stops serving content to that endpoint, effectively removing the logo without disrupting the underlying stream. This approach provides seamless integration across multiple streaming software platforms without requiring custom plugins or modifications to existing streamer workflows.

Third-Party Service Dependencies are now discussed. In an example implementation leverages external artificial intelligence services rather than developing proprietary machine learning models. AssemblyAI™ can serves as an example transcription service, though the architecture supports multiple transcription providers including Google Cloud™ and AWS™ transcription services. Brand safety protection system 600 similarly can use/leverage external Large Language Model (LLM) services for contextual content analysis rather than training custom natural language processing models, allowing for rapid deployment and access to state-of-the-art AI capabilities without significant infrastructure investment.

Contextual disambiguation capabilities of Brand safety protection system 600 are now discussed. A critical functionality involves Brand safety protection system 600′s ability to distinguish between benign and harmful uses of potentially problematic language through contextual analysis. The LLM service evaluates ambiguous content (e.g. such as determining whether someone using the word “dick” is referring to a nickname for Richard versus employing it in an offensive context). This contextual understanding prevents false positive content flagging that could unnecessarily interrupt legitimate advertising opportunities while maintaining brand safety standards.

Real-Time Processing Architecture examples are now discussed. Brand safety protection system 600 can use real-time capabilities that depend on audio segmentation strategies that break continuous streams into manageable chunks rather than processing entire streams simultaneously. This chunking approach enables immediate analysis and response while managing computational resources efficiently.

The text transcription analysis employs a large language model service that implements transformer-based neural network architectures, such as BERT or GPT variants, to perform contextual natural language processing on the transcribed content. The large language model service receives the text transcription as input tokens, processes them through multiple attention layers that analyze semantic relationships and contextual meaning, and generates numerical content moderation scores representing the probability of various content categories including profanity, hate speech, violent content, or other potentially problematic language. The service utilizes pre-trained weights fine-tuned on content moderation datasets and applies classification heads that output confidence scores for different content violation types, with scores typically normalized to ranges between 0.0 and 1.0 representing benign to highly problematic content respectively.

The decision engine module implements a rule-based threshold evaluation system using configurable parameter sets that define acceptable content moderation score ranges for different content categories. The module employs comparison circuitry that performs automated mathematical operations, comparing each content moderation score against corresponding predefined threshold values stored in configuration databases. The thresholds are technically implemented as floating-point values that can be customized per client, topic category, or content type, with the decision engine using Boolean logic operations to determine whether scores exceed acceptable limits. When any content moderation score surpasses its corresponding threshold, the decision engine triggers state machine transitions that generate control signals for downstream response actions, implementing a binary decision tree that outputs either SHOW_AD or HIDE_ADstates based on the threshold comparison results.

The platform chat interaction capture process employs real-time API polling mechanisms or WebSocket connections that interface with streaming platform chat systems to extract text messages, timestamps, user identifiers, and metadata in structured JSON format. Brand safety protection system 600 implements chat parsing algorithms that handle platform-specific formatting including emotes, Unicode characters, and special chat commands, while maintaining message ordering through timestamp synchronization and buffering mechanisms that account for network latency variations.

The potentially problematic language detection utilizes natural language processing pipelines that implement tokenization, part-of-speech tagging, and named entity recognition to identify flagged terms within the text transcription. The detection system employs both static blacklist matching using hash tables for O(1) lookup performance and dynamic pattern recognition through regular expressions and fuzzy string matching algorithms that account for character substitutions, leetspeak variations, and deliberate misspellings commonly used to evade basic filtering systems.

The contextual analysis leverages large language model services that have been specifically fine-tuned for content moderation through supervised learning on curated datasets containing labeled examples of benign versus harmful language usage. The LLM training process implements transfer learning, starting with pre-trained transformer models and applying additional training epochs using content moderation datasets that include contextual examples such as “dick” referring to the name Richard versus offensive usage. The fine-tuning process employs techniques including parameter-efficient fine-tuning (PEFT), low-rank adaptation (LoRA), and prompt engineering to optimize the model's ability to distinguish context without requiring full model retraining. The training optimization utilizes cross-entropy loss functions that penalize misclassification of contextual usage, with gradient descent algorithms adjusting attention weights and embedding representations to improve contextual understanding. Brand safety protection system 600 implements active learning feedback loops that incorporate human reviewer corrections and false positive/negative examples back into the training pipeline, enabling continuous model improvement through techniques such as reinforcement learning from human feedback (RLHF) and online learning algorithms that update model parameters based on real-world performance metrics.

Controlling visibility of digital advertisements in the live streaming environment involves a multi-layered technical implementation that operates through browser source integration and real-time API communication protocols. Brand safety protection system 600 utilizes streaming software platforms such as OBS Studio or StreamElements that support browser source overlays, where advertisements are rendered as HTML/CSS/JavaScript components embedded within the streamer's broadcast scene. The visibility control mechanism implements WebSocket or HTTP REST API endpoints that communicate with the streaming platform's overlay management system, sending JSON-formatted commands that include overlay identifiers, visibility states, and timestamp metadata.

The technical implementation employs DOM manipulation techniques where the logo control module transmits JavaScript commands to modify CSS display properties, opacity values, or z-index layering of advertisement elements in real-time or where the logo control module transmits a control signal to the streaming software to hide a digital advertisement directly. Brand safety protection system 600 maintains persistent connections to advertisement serving platforms through secure HTTPS protocols, utilizing authentication tokens such as JWT or OAuth2 for authorized API access. When violation conditions are detected, the control system executes immediate visibility changes by sending POST requests to ad-serving endpoints that contain overlay removal instructions, causing the advertisement elements to be dynamically hidden through CSS property modifications such as “display: none” or “visibility: hidden” without disrupting the underlying video stream.

The restoration process implements timeout-based recovery mechanisms using programmable timers and state persistence in distributed cache systems like Redis, enabling automatic advertisement restoration after predetermined intervals. Brand safety protection system 600 employs acknowledgment protocols that confirm successful visibility changes through HTTP response codes and maintains fallback mechanisms including circuit breakers and retry logic to ensure reliable advertisement control even during network interruptions or API service degradation.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States Patent:

1. A real-time live streaming content monitoring and automated response control method for processing continuous audio data streams, the system comprising:
capturing a live audio stream from a streaming platform;
processing the live audio stream through an audio preprocessing module to segment the live audio stream into audio chunks;
transmitting the audio chunks to a transcription service to generate a text transcription of spoken content;
analyzing the text transcription using a large language model service to generate a content moderation score;
evaluating the content moderation score against predefined brand safety thresholds using a decision engine module; and
controlling visibility of a digital advertisement in the live streaming environment based on the evaluation, wherein the digital advertisement is hidden when the content moderation score exceeds the predefined brand safety thresholds.

2. The method of claim 1, further comprising:
capturing a platform chat interaction corresponding to the live audio stream;
analyzing the platform chat interactions to generate a chat moderation score; and
incorporating the chat moderation score into the evaluation of the content moderation score against the predefined brand safety thresholds.

3. The method of claim 2, wherein analyzing the text transcription comprises:
detecting a potentially problematic language in the text transcription;
performing contextual analysis using the large language model service to distinguish between benign and harmful uses of the potentially problematic language; and
generating the content moderation score based on the contextual analysis.

4. The method of claim 3, further comprising:
extracting prosodic features from the live audio stream, wherein the prosodic features include at least one of pitch variation, speech rate, and volume;
analyzing the prosodic features using a neural network to determine an emotional tone of a content creator;
generating an emotional tone score based on the emotional tone; and
incorporating the emotional tone score into the evaluation against the predefined brand safety thresholds.

5. The method of claim 4, wherein the decision engine module implements multiple operational states comprising:
an CONTENT_OK state as a default safe state;
an ANALYSIS_PARTIAL state during initial content evaluation;
an ANALYSIS_FULL state during comprehensive contextual analysis; and a
CONTENT_BAD state when brand safety violations are confirmed.

6. The method of claim 5, further comprising:
determining that deeper contextual analysis is required based on the content moderation score;
capturing extended audio context spanning a predetermined time period of historical content;
submitting the extended audio context to the transcription service for enhanced analysis;
generating an enhanced content moderation score based on the enhanced analysis; and
re-evaluating the enhanced content moderation score against the predefined brand safety thresholds.

7. The method of claim 1, further comprising:
receiving feedback on flagged content from an advertiser;
updating the predefined brand safety thresholds based on the feedback through a self-training feedback loop; and
refining decision-making criteria to reduce false positives and improve accuracy of brand safety determinations.

8. The method of claim 9, wherein controlling visibility of the digital advertisement comprises:
sending a HIDE_AD command to a logo control module when the content moderation score exceeds the predefined and/or configurable brand safety thresholds;
transmitting a request to an ad serving platform to remove the digital advertisement from a browser source embedded in streaming software; and
confirming successful execution of advertisement removal while maintaining continuity of the live streaming environment.

9. A real-time live streaming content monitoring and automated response control system for processing continuous audio data streams, the system comprising:
a stream capture module comprising specialized hardware circuitry configured to capture live audio streams from streaming services and extract audio data packets in real-time;
an audio preprocessing module comprising digital signal processing hardware configured to receive encoded audio data from the stream capture module, convert audio formats through hardware-based codec transformation, and segment a continuous audio stream into audio chunks of predetermined duration;
a content analysis module comprising network interface hardware configured to transmit the audio chunks to external transcription services via secure API protocols and receive text-based transcriptions through encrypted data transmission channels;
a contextual analysis module comprising machine learning processing units configured to perform computational content evaluation operations when potential brand safety violations are detected by the content analysis module;
a decision engine module comprising state machine hardware configured to evaluate content moderation scores against client-configured safety thresholds through automated threshold comparison circuitry and manage operational state transitions; and
a logo control module comprising advertisement control hardware configured to interface with ad-platform servers through network protocols to execute real-time visibility commands from the decision engine module by modifying browser source data streams.

10. The real-time live streaming content monitoring and automated response control system of claim 9, wherein the stream capture module comprises platform-agnostic interface hardware configured to extract audio data packets from multiple streaming platforms including Twitch, YouTube, and Kick through standardized API communication protocols implemented in dedicated processing circuitry.

11. The real-time live streaming content monitoring and automated response control system of claim 10, wherein the audio preprocessing module comprises:
codec conversion hardware configured to transform audio formats from AAC-LC encoded via MPEG-TS into PCM16_LE format through dedicated audio processing chips; and
segmentation circuitry configured to divide the continuous audio stream into the audio chunks of approximately 400 ms duration through precise timing control hardware.

12. The real-time live streaming content monitoring and automated response control system of claim 10, wherein the content analysis module comprises:
transmission hardware configured to send the audio chunks to live transcription services endpoints through secure network protocols;
score extraction circuitry configured to parse and extract moderation scores directly from API responses when the transcription services include built-in content moderation capabilities;
classification interface hardware configured to transmit extracted text to LLM-based classification services through dedicated communication channels; and
analysis determination circuitry configured to automatically evaluate content flags and trigger deeper contextual analysis through hardware-based decision logic.

13. The real-time live streaming content monitoring and automated response control system of claim 12, wherein the contextual analysis module comprises specialized processing hardware configured to operate in two distinct computational modes comprising:
text analysis circuitry configured to process larger text context windows using AI-powered classification services via LLM endpoints through dedicated natural language processing hardware; and audio analysis circuitry configured to capture extended audio context spanning approximately 15 seconds of historical content through buffer memory hardware and submit a larger audio segment to specialized transcription services via enhanced transmission protocols.

14. The real-time live streaming content monitoring and automated response control system of claim 13, wherein the decision engine module comprises state machine hardware configured to implement multiple operational states through dedicated control circuitry comprising:
default state hardware implementing an CONTENT_OK state as a baseline operational mode;
partial analysis state hardware implementing an ANALYSIS_PARTIAL state during initial content evaluation;
full analysis state hardware implementing an ANALYSIS_FULL state during comprehensive contextual analysis; and
violation state hardware implementing a CONTENT_BAD state when brand safety violations are confirmed through automated detection circuitry.

15. The real-time live streaming content monitoring and automated response control system of claim 14, wherein the decision engine module comprises:
binary decision circuitry configured to generate content safety determinations comprising SHOW_AD signals to maintain logo visibility or HIDE_AD signals to remove brand elements from a stream through automated switching hardware; and
configuration processing hardware configured to implement client-specific parameters including per-topic threshold comparison circuits aligned with IAB taxonomy categories, safety mode selection switches for conservative, balanced, or aggressive response profiles, and timeout control circuitry for recovery timing management.

16. The real-time live streaming content monitoring and automated response control system of claim 9, wherein the logo control module comprises:
logo removal hardware configured to transmit removal requests to eliminate a client's logo from a browser source embedded in streaming software upon receiving a HIDE_AD command from the decision engine module through dedicated control signaling;
logo restoration hardware configured to transmit restoration requests to re-enable ad serving to a browser source endpoint upon receiving a SHOW_LOGO command from the decision engine module through automated control protocols; and
acknowledgment processing circuitry configured to generate confirmation responses verifying successful execution of visibility changes while maintaining real-time communication with ad serving infrastructure through network monitoring hardware.
